(19) United States
(12) Patent Application Publication
(10) Pub. No.: US 2005/0229235 A1
(43) Pub. Date: Oct. 13, 2005

(54) Clock recovery for a dvb-t to dvb-s transmodulator

(75) Inventor: Philippe Loyer, Paris (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/518,255

(22) PCT Filed: Jun. 13, 2003
(86) PCT No.: PCT/IB03/02954

§ 371 Date: Dec. 16, 2004

(30) Foreign Application Priority Data
Jun. 25, 2002 (EP) 02291577.1

(51) Int. Cl. H04N 7/16

(52) U.S. Cl. 725/152

(57) ABSTRACT

The invention relates to a clock recovery system for a transmodulator allowing reception of a COFDM/DVB-T video signal encoded in the Terrestrial Digital Video Broadcasting format (DVB-T), via a terrestrial antenna and via a DVB-S like receiver suited to receive a QPSK/DVB-S video signal-encoded in the Satellite Digital Video Broadcasting format (DVB-S).

### FIELD OF THE INVENTION

The invention relates to digital transmission. It particularly relates to a converter apparatus for producing, from a first encoded signal supplied by a data source in a first encoding format at a first data rate, a second signal encoded in a second encoding format at a second data rate.

The invention advantageously applies, in digital television, to a receiver and to a converter apparatus allowing reception of a DVB-T video signal encoded in the Terrestrial Digital Video Broadcasting format (DVB-T) via a terrestrial antenna and via a DVB-S like receiver suited for receiving a DVB-S video signal encoded in the Satellite Digital Video Broadcasting format (DVB-S).

### BACKGROUND OF THE INVENTION

The international patent application published under number WO 99/37093 describes a system for the distribution, in a collective environment, of a plurality of television signals, transmitted with different standards. In accordance with the system, one or more digital signals can be received by a single user of the system by means of a frequency conversion into a predetermined channel, which can be accessed by said user only. The digital signal being present in said channel always has the same modulation and can be selected by said user through control means, which send a control signal to selection means. It is thereby prevented that the user of a collective environment has different types of modulators with respect to the different digital signals available to the collective environment. The system applies to collective distribution of different digital television signals to a plurality of receivers, for enabling the plurality of receivers to receive the programs, which reach the collective environment. It does not apply to individual reception, using a single receiver, of a digital television signal transmitted with a standard, which is different from the standard compatible with the single receiver.

### OBJECT AND SUMMARY OF THE INVENTION

It is an object of the invention to allow individual reception of a digital signal coming from a terrestrial channel, using a satellite receiver for the reception of the terrestrial digital signal.

The invention takes the following aspects into consideration. Digital terrestrial television has started in a few European countries (e.g. United Kingdom, Sweden, Spain, etc.) and is now expanding to most European countries. Depending on the added value of new program offers, consumers are more or less reluctant to get the appropriate additional equipment (set-top box) needed to receive the new programs, which are transmitted in a specific digital format (DVB-T). Until now, the growth rate of subscriptions to the DVB-T television standard has been relatively low, partly due to the cost of the additional set-top box equipment. However, there is already a considerable number of installed DVB-S set-top boxes, the owners of which are not ready to pay for an extra, relatively costly and cumbersome, set-top box. Furthermore, existing DVB-S service providers, who want to launch a new DVB-T service, would have to invest a lot of money to acquire appropriate equipment.

Therefore, the present invention provides DVB-T to DVB-S converting means for converting a DVB-T signal into a DVB-S signal to be processed by a DVB-S like set-top box using a simple and inexpensive converter as an add-on to the existing DVB-S set-top box, possibly without any hardware adaptation on the box. The DVB-S set-top box users would thus be able to re-use their existing box to receive new DVB-T programs by adding a low cost converter, and DVB-S service providers would be able to re-use their already installed base of set-top boxes, thus limiting their investment.

The basic consumer converter box in accordance with the invention performs a transmodulation of an OFDM signal into a QPSK signal. It comprises an ODFM demodulator and a QPSK re-modulator. However, this transmodulation leads to a difficulty regarding to the QPSK symbol rate generation. The QPSK symbol rate frequency must be stable for a proper operation of the satellite receiver and should be locked to the OFDM transmission data rate.

The invention provides a transmodulator applicable to OFDM towards QPSK transmodulation. It provides means for generating e.g. an QPSK symbol rate clock at low cost for a consumer product. To this end, a converter apparatus of the type mentioned in the opening paragraph is provided, the converter comprising:
decoding means for decoding the first encoded signal and for producing a decoded signal,
encoding means for encoding said decoded signal into a second encoded signal,
clock recovery means comprising an oscillator having a control frequency controlled by two complementary loops for producing a symbol clock for the encoding means, which is locked on the first data rate, the two complementary loops including a coarse loop using a free running reference clock and programmable dividing means for enabling the oscillator to reach a frequency which is close to a predetermined nominal frequency within a predefined tolerance range, and a fine loop using buffering means allowing control of the second data rate with respect to the first data rate by increasing/decreasing the oscillator-controlled frequency when the buffering means fills up/empties,
control means for controlling the decoding means, the encoding means and the coarse loop dividing means.

A receiver suitable for receiving a DVB-S signal encoded in the Satellite Digital Video Broadcasting format (DVB-S) is also provided, said receiver comprising a converter device for producing, from a received OFDM modulated DVB-T signal, a QPSK modulated signal encoded in the Satellite Digital Video Broadcasting format (DVB-S), said converter device comprising:
demodulation means for demodulating the received OFDM modulated DVB-T signal and for providing a demodulated DVB-T signal,
modulation means for re-modulating said demodulated DVB-T signal TS into a QPSK modulated signal,
clock recovery means for providing, from an oscillator having a frequency controlled by two complementary loops, a symbol clock for the QPSK modulator, which is locked on the OFDM modulated DVB-T signal data rate, the two complementary loops including a coarse loop using a free running reference clock and programmable dividing means for enabling the oscillator to reach a frequency which is close to a predetermined nominal frequency within a predefined range, and a fine loop using buffering means allowing control of the data rate between the OFDM demodulator and the QPSK modulator by increasing/decreasing the oscillator-controlled frequency when the buffering means fills up/empties,
control means for controlling the demodulation means, the modulation means and the coarse loop dividing means.

In accordance with another embodiment, a converter apparatus of the type mentioned in the opening paragraph is provided, the converter comprising:
decoding means for decoding the first encoded signal and for producing a decoded signal,
encoding means for encoding said decoded signal into a second encoded signal,
clock recovery means comprising an oscillator having a control frequency controlled by a control loop for producing a symbol clock for the encoding means, which is locked on the first data rate, the control loop using buffering means allowing control of the second data rate with respect to the first data rate by increasing/decreasing the oscillator-controlled frequency when the buffering means fills up/empties,
control means for controlling the decoding means, the encoding means and for forcing a nominal value into the oscillator corresponding to a nominal symbol clock rate for the encoding means.

A receiver suitable for receiving a DVB-S signal encoded in the Satellite Digital Video Broadcasting format (DVB-S) is also provided, said receiver comprising a converter device for producing, from a received OFDM modulated DVB-T signal, a QPSK modulated signal encoded in the Satellite Digital Video Broadcasting format (DVB-S), said converter device comprising:
demodulation means for demodulating the received OFDM modulated DVB-T signal and for providing a demodulated DVB-T signal,
modulation means for re-modulating said demodulated DVB-T signal into a QPSK modulated signal,
clock recovery means comprising an oscillator having a control frequency controlled by a control loop for producing a symbol clock for the encoding means, which is locked on the the OFDM modulated DVB-T signal data rate, the control loop using buffering means allowing control of the data rate between the OFDM demodulator and the QPSK modulator by increasing/decreasing the oscillator-controlled frequency when the buffering means fills up/empties,
control means for controlling the demodulation means, the modulation means and for forcing a nominal value into the oscillator corresponding to a nominal symbol clock rate for the modulation means.

### BRIEF DESCRIPTION OF THE DRAWINGS

These and other aspects of the invention are apparent from and will be elucidated with reference to the embodiments described hereinafter. In the drawings:

FIG. 1 is a conceptual block diagram illustrating a converter apparatus in accordance with the invention,

FIG. 2 is a conceptual block diagram illustrating a converter apparatus in accordance with a particular embodiment of the invention,

FIG. 3 is a conceptual block diagram illustrating a converter apparatus in accordance with another embodiment of the invention.

### DETAILED DESCRIPTION OF THE DRAWINGS

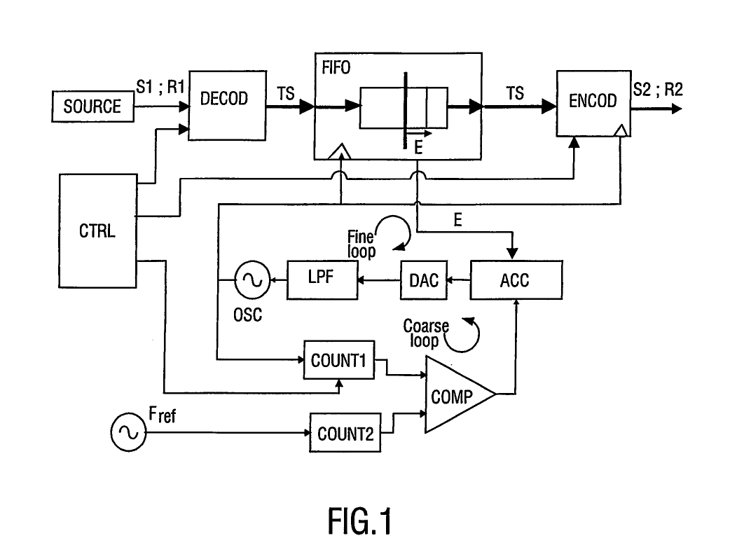

FIG. 1 illustrates an apparatus in accordance with the invention for producing, from a first encoded signal S1 supplied by a data source SOURCE in a first encoding format at a first data rate R1, a second signal S2 encoded in a second encoding format at a second data rate R2. Due to the implementation of the decoder, the instantaneous data rate R1 is not constant. The particularity of the second data rate R2 is to have an instantaneous data rate constant and it is locked to the average of the data rate R1. The converter apparatus comprises:
decoding means DECOD for decoding the first encoded signal S1 and for producing a decoded signal, denoted TS
encoding means for encoding said decoded signal into a second encoded signal S2,
clock recovery means comprising an oscillator OSC having a control frequency FOSC controlled by two complementary loops, for producing a symbol clock for the encoding means ENCOD, which is locked on the first data rate R1, the two complementary loops including a coarse loop using a free running reference clock F_{ref} and programmable dividing means COUNT1 and COUNT2 for enabling the oscillator OSC to reach a frequency FOSC which is close to a predetermined nominal frequency Fno within a predefined tolerance range, and a fine loop using buffering means FIFO allowing control of the second data rate R2 with respect to the first data rate R1 by increasing/decreasing the oscillator-controlled frequency FOSC when the buffering means fills up/empties,
control means CTRL for controlling the decoding means, the encoding means and the coarse loop dividing means.

Instead of a separate apparatus to be connected as an add-on to a regular DVB-S receiver, the invention may be implemented within a single receiver, which would have the same features as a regular DVB-S receiver plus, in addition, at least the features of the above-mentioned converter apparatus. Such a receiver is not shown, because all of its features are easily derivable from the features shown in FIG. 1.

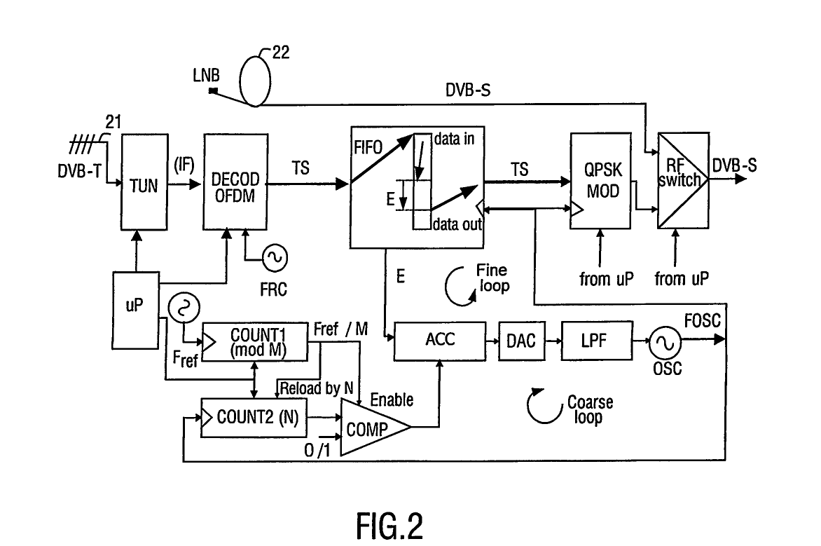

FIG. 2 shows a converter apparatus in accordance with a preferred embodiment of the invention. It is dedicated to an OFDM to QPSK transmodulation for converting a received terrestrial signal compliant with the DVB-T standard into a satellite signal compliant with the DVB-S standard to be supplied to a standard satellite receiver. The features of the transmodulator illustrated in FIG. 2 provide the following effects. A tuner TUN receives from a terrestrial antenna 21 the OFDM terrestrial DVB-T video signal and supplies a multiplexed video signal in an intermediate frequency (IF) compatible with the OFDM demodulator (at e.g. 36.125 MHz) to a decoder DECOD OFDM. The decoder includes channel decoding and OFDM demodulation for decoding the multiplexed signal and recovering the MPEG-2 “transport stream” signal, denoted TS, corresponding to the transmitted multiplexed digital video signal, which includes a set of television programs encoded in accordance with the MPEG-2 standard. From this “transport stream” TS, a modulator QPSK MOD builds up a QPSK modulated DVB-S signal suitable to be applied to a DVB-S standard receiver. DVB-S receivers accept QPSK modulated input signals in the Satellite Intermediate Frequency band (950 to 2150 MHz).

Before re-modulation into a QPSK signal, the transport stream TS is provided to a FIFO (first in first out) buffer. The FIFO buffer is used to average the data rate between the OFDM demodulator output and the QPSK re-modulator input. This FIFO provides an indication about its data occupancy. The nominal data may correspond e.g. to half the data buffer size. The deviation of the data occupancy from this nominal position is indicated by an error signal E.

The QPSK modulator MOD then converts the data stream into a QPSK DVB-S signal. A RF switch is possibly provided to select the signal to be transmitted to the satellite receiver from the satellite signal coming from the low noise block (LNB) of a satellite antenna 22 and the data stream provided at the output of the QPSK re-modulator. This switch can be controlled by a microprocessor.

A comparator COMP receives the outputs of a pair of down-counters COUNT1 and COUNT2. Both down-conter count in decreasing order according to a free running clock frequency F_{ref}. The first down-counter COUNT1 (mod M) has an output activated every F_{ref}/M time intervals to activate the comparator COMP and to reload the second down-counters COUNT2 by N units. The value of the comparator output is proportional to the N down-counter value found every F_{ref}/M. This comparator output is not active (e.g. equal to 0) if the N down-counter value found is either 0 or 1.

An accumulator and filter ACC performs a sum and a filtering of the oscillator frequency correction from both comparator output and error E derived from the current data buffer occupancy. A digital-to-analog converter DAC converts the output signal from the accumulator and filter ACC into an analog signal. A low-pass filter LPF filters the analog signal and produces a filtered analog signal to the oscillator to generate the new QPSK symbol clock destined to regulate the QPSK re-modulator.

The QPSK modulator MOD may comprise some error correction algorithms, like the standard DVB-S forward error correction algorithm, known as FEC (Forward Error Correction) algorithms using e.g. a Reed-Solomon code followed by a Viterbi convolutional algorithm. The aim of this forward error correction algorithm is to encode the received bitstream to be supplied to the DVB-S receiver according to the format expected by a DVB-S compliant receiver. It allows correction at reception transmissions errors, which may have occurred during transmission of the DVB-T signal though the terrestrial channel. The demodulated DVB-T signal, which is available at the output of the FIFO, can be done after the error correction (MPEG transport stream). It can be done before the error correction, and used “as is” to drive the QPSK modulator MOD, after some usual processing such as conversion from serial to I/Q format, which is the format suited for QPSK modulation, level adaptation and pulse shaping (i.e. Nyquist filtering). This alternative, simpler way of signal processing allows avoiding the full DVB-S encoding stages. In principle, it is possible to avoid the FEC error correction at the QPSK re-modulation stage, because satellite (DVB-S) and terrestrial (DVB-T) digital television standards use the same forward error correction mechanisms and parameters. Actually, the OFDM demodulated QPSK re-modulated signal applied to the DVB-S receiver may possibly contain errors. However, these errors will normally be within the correction possibilities of the FEC error correction stages of the DVB-S demodulator, which is included in the DVB-S standard receiver. The demodulated DVB-T signal, which is available at the output of the FIFO, can be done also after a part of the error correction (Viterbi decoder output), with the advantage of using the Viterbi decoder of the DVB_T decoder to correct a certain amount of errors present on the terrestrial reception, knowing that the concatenated encoding performed in the re-modulator is a simple operation. The advantage of this partial error decoding is to add a flexibility on data rate value of the re-modulator by adding more redundancy in the concatenated encoder of the re-modulator, as defined in the DVB_S concatenate code scheme (½, ⅔, ¾, ⅚ or ⅞).

A microprocessor uP controls the different parts of the system:
the terrestrial channel reception in the tuner,
the OFDM demodulator for the DVB_T demodulation,
the QPSK re-modulator for the DVB_S inner code rate control, if needed,
the RF switch to select the signal applied to the satellite receiver from either the satellite LNB or from the QPSK re-modulator.
The N and M values of decounters.

The two complementary coarse and fine loops, which control the oscillator OSC for generating the QPSK symbol rate clock, will be described hereinafter.

The coarse loop is based on a classical Phase-Locked-Loop PLL using programmable decounters and a free running reference clock, which produces a reference signal at the reference frequency F_{ref} (4 MHz, for example). It controls the oscillator to reach the nominal frequency Fₙₒ=F_{ref}*N/M. The coarse loop is characterized by an elementary step frequency. It stops controlling the oscillator when the nominal frequency is reached within a predefined tolerance range, e.g. equivalent to a 2-step frequency tolerance. That is to say, the coarse loop does not apply any oscillator correction when it is locked on the nominal frequency F_{ref}*M/N plus or minus one PLL frequency step (one PLL frequency step=F_{ref}/M). Then, the fine loop takes over the oscillator control for a finer control based on a buffer filling rate.

The fine loop is based on the detection of the number of data in the FIFO buffer. This FIFO buffer is used to smooth the data rate between the OFDM demodulator and the QPSK re-modulator. This fine loop increases/decreases the VCO control frequency when the number of data (regarding a nominal value) of the FIFO increases/decreases. The nominal value of data in the FIFO may correspond e.g. to half the total FIFO capacity.

The main advantage of using two complementary loops is that it provides a symbol clock for the QPSK re-modulator at the frequency Fₙₒ which allows avoing any jitter coming from the digital asynchronous OFDM demodulator.

The invention may be implemented in accordance with various options stated hereinafter. The clock QPSK modulator may be a multiple of the symbol frequency, e.g. 2 times the symbol frequency for implementation issues in the QPSK re-modulator. The free running clock F_{ref} can also be shared with the free running clock of the OFDM demodulator FRC and the one of the terrestrial tuner (not shown). As already mentioned, the DVB-T and DVB-S standards use the same forward error correction (FEC): concatenated code, interleaver Reed Solomon coding, scrambler. To reduce the complexity of the QPSK re-modulator, the data output of the DVB-T reception, i.e. ODFM demodulator output, can be defined as MPEG transport stream data or, inner decoder output (e.g. Viterbi decoder), or OFDM symbol output or other part of the FEC scheme. The oscillator may be a voltage-controlled oscillator VCO or a digital oscillator NCO.

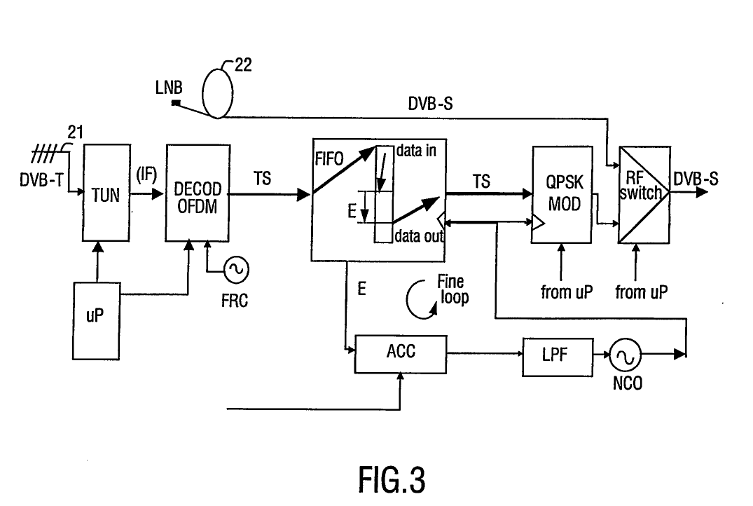

FIG. 3 illustrates an embodiment of the invention, wherein the oscillator is a digital oscillator NCO. The same entities are designated by the same letter references in both FIG. 2 and FIG. 3. In this case, the coarse loop (counters 1 and 2 and the comparator of FIG. 2) is replaced by loading, from the uP into the accumulator of the NCO, the nominal value of the NCO corresponding to the nominal symbol clock rate for the QPSK re-modulator.

The drawings and their description hereinbefore illustrate rather than limit the invention. It will be evident that there are numerous alternatives, which fall within the scope of the appended claims. In this respect, the following closing remarks are made.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions, nor does it exclude that a function is carried out by an assembly of items of hardware or software, or both.

Any reference sign in a claim should not be construed as limiting the claim. Use of the verb “to comprise” and its conjugations does not exclude the presence of elements or steps other than those stated in a claim. Use of the article “a” or “an” preceding an element or step does not exclude the presence of a plurality of such elements or steps.

### DEFINITION OF ABBREVIATIONS

DVB-S: Satellite Digital Video Broadcasting
DVB-T: Terrestrial Digital Video Broadcasting
FEC: Forward Error Correction
OFDM: Orthogonal Frequency Division Multiplexing
QPSK: Quadrature Phase Shift Keying
MPEG-2: Motion Picture Experts Group-2
LNB: Low Noise Block Converter

1. A converter apparatus for producing, from a first encoded signal supplied by a data source in a first encoding format at a first data rate, a second signal encoded in a second encoding format at a second data rate, said converter apparatus comprising:
decoding means for decoding the first encoded signal and for producing a decoded signal,
encoding means for encoding said decoded signal into a second encoded signal,
clock recovery means comprising an oscillator having a control frequency controlled by two complementary loops for producing a symbol clock for the encoding means, which is locked on the first data rate, the two complementary loops including a coarse loop using a free running reference clock and programmable dividing means for enabling the oscillator to reach a frequency which is close to a predetermined nominal frequency within a predefined tolerance range, and a fine loop using buffering means allowing control of the second data rate with respect to the first data rate by increasing/decreasing the oscillator-controlled frequency when the buffering means fills up/empties,
control means for controlling the decoding means, the encoding means and the coarse loop dividing means.

2. A converter apparatus as claimed in claim 1, wherein the buffering means include a First Input First Output buffer having a current filling rate and which fills up at the first data rate and empties at the second data rate, the control frequency of the oscillator being controlled with respect to an estimation of a difference between the current filling rate and a predetermined nominal filling rate.

3. A converter apparatus as claimed in claim 1, wherein the second data rate corresponds to a second symbol frequency, the symbol clock of the encoding means being a multiple of the second symbol frequency.

4. A converter apparatus for producing, from a first encoded signal supplied by a data source in a first encoding format at a first data rate, a second signal encoded in a second encoding format at a second data rate, said converter apparatus comprising:
decoding means for decoding the first encoded signal and for producing a decoded signal,
encoding means for encoding said decoded signal into a second encoded signal,
clock recovery means comprising an oscillator having a control frequency controlled by a control loop for producing a symbol clock for the encoding means, which is locked on the first data rate, the control loop using buffering means allowing control of the second data rate with respect to the first data rate by increasing/decreasing the oscillator-controlled frequency when the buffering means fills up/empties,
control means for controlling the decoding means, the encoding means and for forcing a nominal value into the oscillator corresponding to a nominal symbol clock rate for the encoding means.

5. A receiver for receiving a DVB-S signal encoded in the Satellite Digital Video Broadcasting format (DVB-S), said receiver comprising a converter device for producing, from a received OFDM modulated DVB-T signal, a QPSK modulated signal encoded in the Satellite Digital Video Broadcasting format (DVB-S), said converter device comprising:
demodulation means for demodulating the received OFDM modulated DVB-T signal and for providing a demodulated DVB-T signal,
modulation means for re-modulating said demodulated DVB-T signal in an QPSK modulated signal,
clock recovery means comprising an oscillator having a frequency controlled by two complementary loops, for providing a symbol clock for the QPSK modulator, which is locked on the OFDM modulated DVB-T signal data rate, the two complementary loops including a coarse loop using a free running reference clock and programmable dividing means for enabling the oscillator to reach a frequency which is close to a predetermined nominal frequency within a predefined range, and a fine loop using buffering means allowing control of the data rate between the OFDM demodulator and the QPSK modulator by increasing/decreasing the oscillator controlled frequency when the buffering means fills up/empties,
control means for controlling the demodulation means, the modulation means and the coarse loop dividing means.

6. A receiver for receiving a DVB-S signal encoded in the Satellite Digital Video Broadcasting format (DVB-S), said receiver comprising a converter device for producing, from a received OFDM modulated DVB-T signal, a QPSK modulated signal encoded in the Satellite Digital Video Broadcasting format (DVB-S), said converter device comprising:
demodulation means for demodulating the received OFDM modulated DVB-T signal and for providing a demodulated DVB-T signal,
modulation means for re-modulating said demodulated DVB-T signal into a QPSK modulated signal,
clock recovery means comprising an oscillator having a control frequency controlled by a control loop for producing a symbol clock for the encoding means, which is locked on the the OFDM modulated DVB-T signal data rate, the control loop using buffering means allowing control of the data rate between the OFDM demodulator and the QPSK modulator by increasing/decreasing the oscillator controlled frequency when the buffering means fills up/empties,
control means for controlling the demodulation means, the modulation means and for forcing a nominal value into the oscillator corresponding to a nominal symbol clock rate for the modulation means.
